(19) United States
(12) Patent Application Publication
(10) Pub. No.: US 2012/0040126 A1
(43) Pub. Date: Feb. 16, 2012

(54) Blank of a Machine Component Comprising Teeth, and Method of Producing Such a Machine Component

(75) Inventor: Tobias Hofmann, Stoettwang (DE)

(73) Assignee: HIRSCHVOGEL UMFORMTECHNIK GMBH, Denklingen (DE)

(21) Appl. No.: 13/178,692

(22) Filed: Jul. 8, 2011

(30) Foreign Application Priority Data
Aug. 12, 2010 (DE) 10 2010 039 251.0

(51) Int. Cl. B32B 3/02; B23F 1/00

(52) U.S. Cl. 428/66.1; 409/10

(57) ABSTRACT

A blank of a machine component comprising teeth, and a method of producing a corresponding machine component. The blank has a surface provided to constitute outside-face end regions of the teeth, and has indentations, which are preferably realized by a forming operation, boundaries of the indentations constituting edge regions of the surface. In the alteration of the blank for the purpose of realizing the machine component, the teeth can be realized in such a way that remaining regions of the indentations constitute chamfers of tooth flanks of the teeth. Burr strands, which would have to be removed in a further operation, can thereby be prevented.

### BACKGROUND OF THE INVENTION

1. Field of the Invention

The invention relates to a blank of a machine component comprising teeth, the blank having a surface provided to constitute outside-face end regions of the teeth. Furthermore, the invention relates to a method for producing a corresponding machine component. The machine component can be, in particular, a gearwheel.

2. Related Technology

For the purpose of producing a machine component that comprises teeth, it is known to produce first a blank of the machine component and then to realize the teeth by a milling or grinding operation. In this case there is the problem that, generally, the milling or grinding operation causes burr strands, or sharp-edged transitions, to form at the outside-face end regions of the teeth, which burr strands have to be removed in a further operation.

FIG. 10 is intended to illustrate an example of this. Shown here is a corresponding machine component, in the form of a crown gearwheel. At locations that are marked by two circles, by way of example, burring occurs as a result of the milling of the toothing. Generally, such a burring is particularly pronounced in the case of an exit location or exit surface of the respective milling or grinding tool. The thus formed burr strands then have to be removed. According to the prior art, this is effected by deburring or chamfering.

Two spur gearwheels are shown in FIG. 11; such burrs 40, or burr strands, are visible in the case of the spur gearwheel shown on the left. In the case of the spur gearwheel shown on the right, chamfer surfaces 42 can be seen, which are produced by material removal.

### SUMMARY OF THE INVENTION

The invention provides a corresponding blank of a machine component that enables the machine component to be produced more easily, and a corresponding production method for such a machine component.

Provided according to the invention is a blank of a machine component comprising teeth, the blank having a surface provided to constitute outside-face end regions of the teeth. The blank has indentations, which are preferably realized by a forming or pressing operation, boundaries of the indentations constituting edge regions of the surface. The indentations can also be produced by material removal.

In the alteration of the blank for the purpose of realizing the finished machine component, the teeth can be realized in such a way that surface regions of the indentations constitute chamfers of tooth flanks of the teeth. Burr strands, which would otherwise have to be removed in a further operation, can thereby be prevented. Chamfers, or chamfer surfaces, are not subject to such stringent requirements, in respect of the precision of the surface formation, as the teeth, or their tooth flanks, as such. Preferably in respect of production, the indentations can be produced as part of the production of the blank, in particular as part of a corresponding forging process. In particular, the indentations can be produced by a forming or pressing operation or by material removal. Moreover, the design of the blank makes it possible to make a saving, although comparatively small, in material.

Preferably, the surface defines a cylindrical surface or a conical surface or a flat surface. A machine component in the form of a gearwheel or toothed rack can thereby be made particularly easily from the blank.

Furthermore, preferably, the indentations are realized and disposed in a uniform manner. This is particularly advantageous if the machine component to be produced from the blank is to have a running gear toothing.

Preferably, each of the edge regions of the surface has a U shape or V shape. Each of the two limbs of the U or V can then serve as an edge region of a chamfer surface of a tooth flank.

Preferably, the blank additionally has a further surface, the further surface being provided to be at least partially removed by a milling or grinding operation, for the purpose of realizing tooth flanks of the teeth, the boundaries of the indentations each constituting a further edge region in the form of an edge region of the further surface.

In a section through the center of one of the indentations, and as viewed perpendicularly in relation to the surface, the angle included by, on the one hand, the end regions of the one indentation that adjoin one another at the edge region and, on the other hand, the surface, preferably is between 100° and 170°, highly preferably between 115° and 155°, and particularly preferably between 130° and 140°. As a result, the indentation is particularly well suited to the making of chamfers for the corresponding tooth flanks.

Preferably, the teeth are teeth of a running gear toothing. The machine component is preferably a gearwheel or a toothed rack. For example, it can be a spur wheel or a crown wheel or a bevel wheel.

If the blank is an annular blank, the indentations are preferably made on an inner side and/or on an outer side of the annular blank.

According to a further aspect of the invention, a method is provided for producing a machine component that has teeth. The method comprises: (a) producing a blank of the machine component, the blank having a surface provided to constitute outside-face end regions of the teeth; (b) making indentations of the blank, preferably by a forming or pressing operation, so that boundaries of the indentations constitute edge regions of the surface; and (c) making tooth flanks of the teeth by a milling or grinding operation, so that outside-face end regions of the tooth flanks directly adjoin regions of the indentations that remain after the milling operation.

Burrs made by the milling or grinding operation, which would otherwise have to be removed in a further operation, can be prevented in this way.

Advantageously in this case, in (c) the milling or grinding operation is effected in such a way that the remaining regions constitute chamfer surfaces between the tooth flanks and the surface. In this way, corresponding chamfer surfaces can be produced particularly easily.

Preferably in this case, (a) and (b) are performed as part of one work process, in particular simultaneously.

In step (a), the blank is preferably produced by a forging operation.

The blank is preferably a blank according to the invention.

### BRIEF DESCRIPTION OF THE DRAWINGS

The invention is explained more fully in the following on the basis of exemplary embodiments and with reference to the drawings, wherein:

FIG. 1 shows an exemplary embodiment of a blank, according to the invention, of a crown gearwheel,

FIG. 2 shows the crown gearwheel made therefrom,

FIG. 3 shows a portion from FIG. 1,

FIG. 4 shows a portion from FIG. 2,

FIG. 5 shows a cross-sectional sketch through one of the indentations,

FIG. 6 shows a variant of the exemplary embodiment shown in FIG. 1,

FIG. 7 shows the crown gearwheel made therefrom,

FIG. 8 shows a portion from FIG. 6,

FIG. 9 shows a portion from FIG. 7,

FIG. 10 shows a crown gearwheel according to the prior art,

FIG. 11 shows a view relating to an embodiment of the invention for the case of a spur gearwheel,

FIG. 12 shows an exemplary embodiment of a blank, according to the invention, of a spur gearwheel,

FIG. 13 shows the spur gearwheel made therefrom,

FIG. 14 shows a further exemplary embodiment of a blank, according to the invention, of a spur gearwheel, and

FIG. 15 shows the spur gearwheel made therefrom.

### DETAILED DESCRIPTION

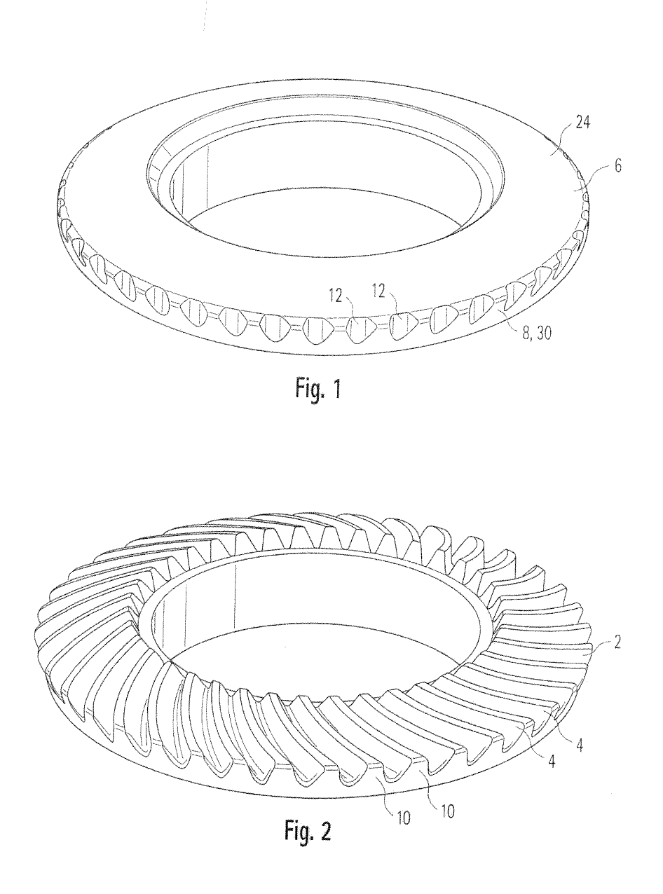

FIGS. 1 and 2 show by way of example a first embodiment of a blank 6, according to the invention, for a machine component, as well as the corresponding machine component 2 made from the blank 6. The machine component 2 comprises teeth 4, or a toothing. The teeth 4 can be, in particular, teeth of a running toothing.

FIGS. 1 and 2 show by way of example the case of a blank 6 of a crown gearwheel 2, and the corresponding crown gearwheel 2, respectively. The following statements relate to the case of such a crown gearwheel 2 but, for persons skilled in the art, can obviously be applied to a correspondingly other machine component having a toothing. In addition to the crown gearwheel shown exemplarily here, the machine component can be, in particular, a gearwheel, for example a gearwheel in the form of a spur wheel or a bevel wheel or also, for example, a toothed rack.

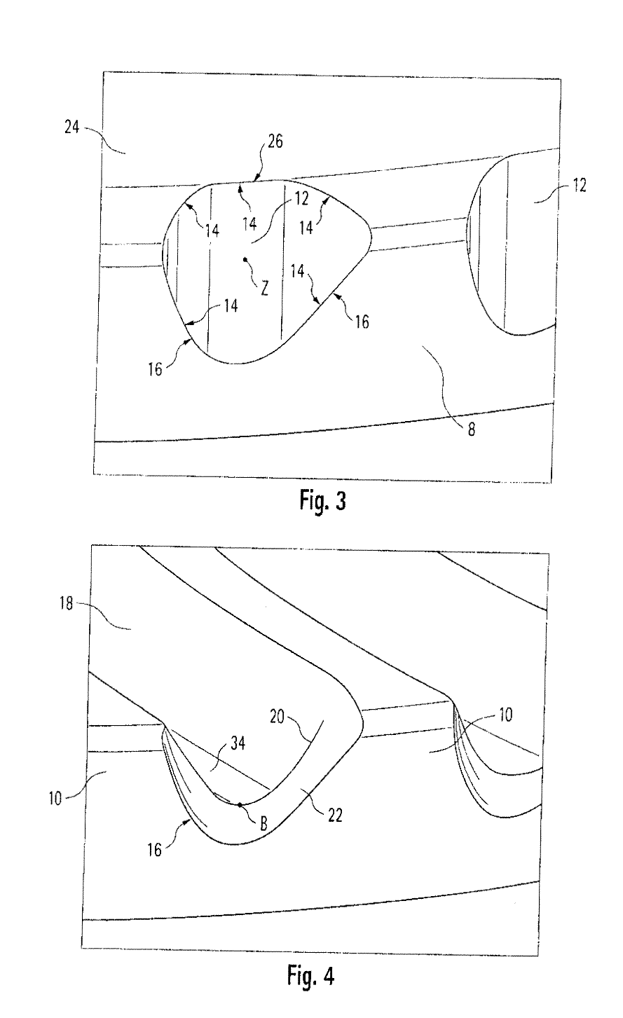

The blank has a surface 8 provided to constitute outside-face end regions 10 of the teeth 4. Furthermore, the blank 6 has indentations 12, which can be made by a forming or pressing operation. Alternatively, the indentations can be produced by material removal. FIG. 3 shows an enlarged portion from FIG. 1. As shown exemplarily by FIG. 3, boundaries 14 of the indentations 12 constitute edge regions 16 of the surface 8. These edge regions 16 can each have, in particular, a U shape or a V shape.

In the subsequent production of tooth flanks of the teeth 4 by a milling or grinding tool, the indentations 12 of the blank 6 can serve as an entrance surface or exit surface for the corresponding tool. It is thereby possible for the tooth flanks and the teeth 4 to be produced so that, in the respective region of the indentation 12, there is no formation of burrs that would otherwise have to be removed in a further operation. The production of the machine component can therefore be made considerably easier in this manner. Regions of the indentations 12 that remain after the tooth flanks of the teeth 4 have been produced can constitute chamfers of the tooth flanks. Chamfer surfaces are not subject to such stringent requirements as the tooth flanks, or the teeth, as such, and can be produced with sufficient accuracy by forming or pressing.

Furthermore, the indentations enable the geometric properties of the subsequent chamfer surfaces to be freely selected, or defined by the configuration of the indentations, within wide ranges.

The surface 8 can be realized, as is the case in the example shown, in such a way that defines, at least in a first approximation, a conical surface. However, it can also be, for example, a surface that defines a cylindrical surface. If the machine component is, for example, a spur gearwheel or a toothed rack, the surface 8 can be a surface that defines a flat surface.

FIG. 4 shows an enlarged portion from FIG. 2. It can be seen that, in the case of the machine component 2 produced, i.e., here, the crown wheel, or crown gearwheel, there can be constituted by the surface 8 regions that, to a first approximation, are triangular or trapezoid, and that constitute the outside-face end regions 10 of the teeth 4. Also evident are regions 22 of the indentations 12 that remain after the milling or grinding operation, which regions constitute chamfers, or chamfer surfaces, of the tooth flanks 18 of the teeth 4.

As can be seen from FIG. 1, it can be provided that the indentations are realized and disposed in a uniform manner. For example, it can be provided in this case that the indentations 12 are disposed along a circular line or, in the case of a toothed rack, along a straight line.

As is evident by way of example from a comparison of FIGS. 1 and 2, the blank 6 can additionally have a further surface 24, which is provided to be at least partially removed by a milling or grinding operation, for the purpose of realizing the tooth flanks 18 (shown in FIG. 4) already mentioned above, the boundaries 14 of the indentations 12 each constituting a further edge region 26 in the form of an edge region 26 of the further surface 24. The indentations 12 in this case, as already mentioned, can serve as an entrance surface or exit surface in the milling or grinding operation for producing the tooth flanks 18.

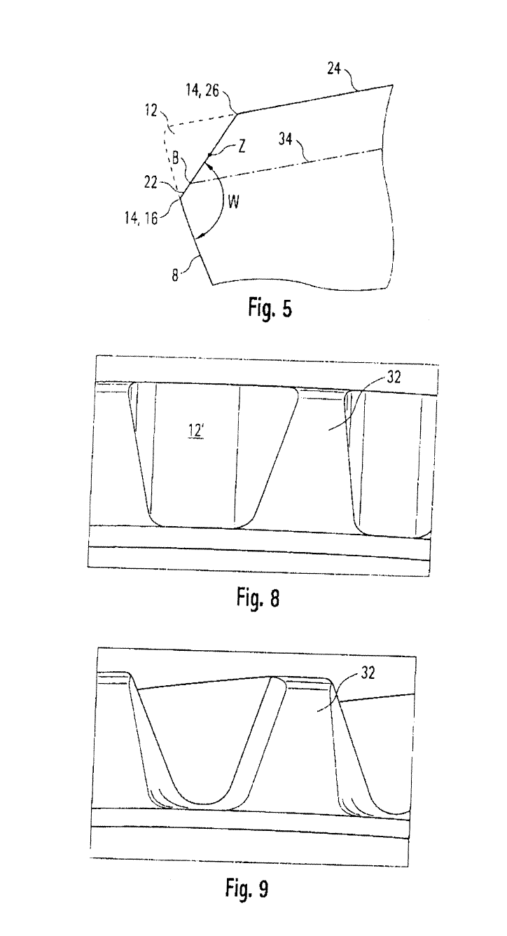

Sketched in FIG. 5 is a cross-section or, in short, a section through the center Z of one of the indentations 12, and perpendicularly in relation to the surface 8. Two opposing tooth flanks 18, and a tooth base region 34 located between the latter, can be produced in a milling or grinding operation, with this indentation 12 being used as an entrance surface or exit surface for the corresponding tool. In FIGS. 4 and 5, the reference B denotes the point at which this tooth base region 34 adjoins the indentation 12, or the remaining region 22 of the indentation 12, i.e., in particular, the correspondingly constituted chamfer region.

The blank 6 is realized, advantageously, in such a way that, as viewed in the said section, the region 22 of the indentation 12, together with an adjoining region of the surface 8, includes an angle W that preferably is between 100° and 170°, highly preferably between 115° and 155°, and particularly preferably between 130° and 140°. This is particularly advantageous because, in this way, the respective indentation 12 can be used to realize particularly suitably shaped chamfers for the two adjoining tooth flanks 18 and the tooth base region 34 located therebetween.

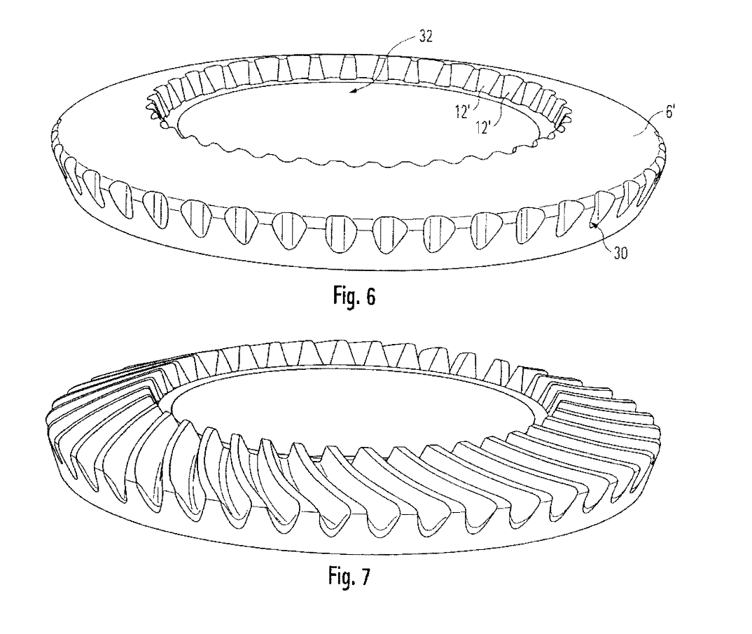

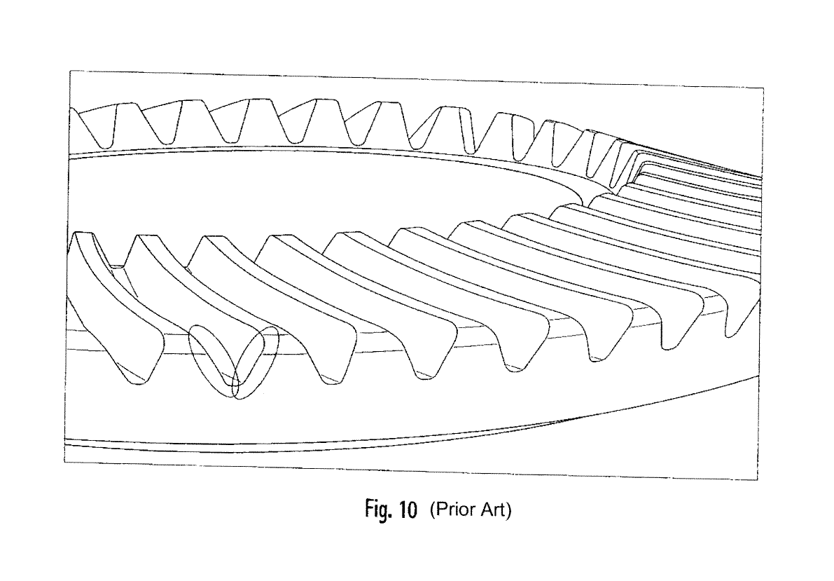

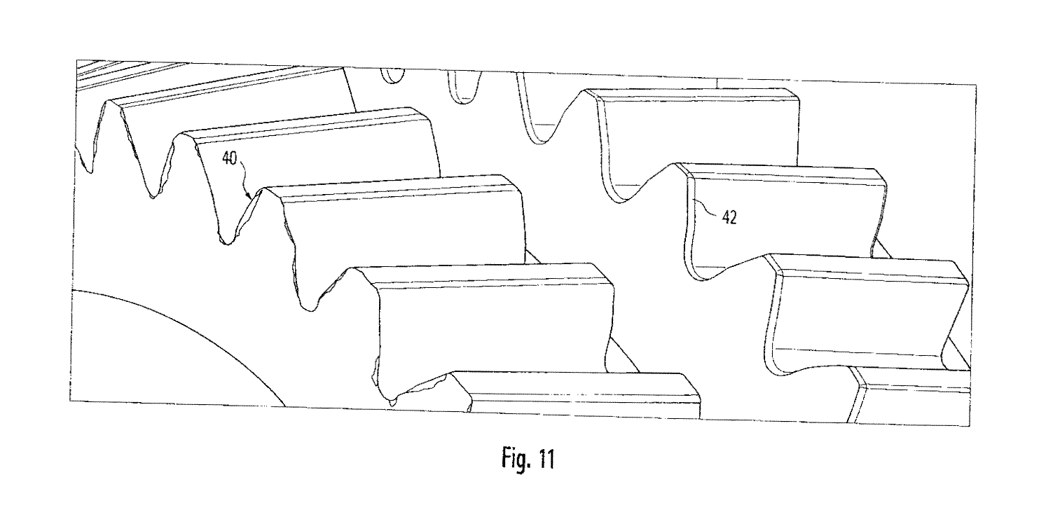

As is further shown by way of example by FIG. 1, the blank 6 can be an annular blank, the indentations 12 being made on an outer side 30 of the annular blank. As furthermore shown, as a variant, in FIGS. 6 and 7, the annular blank 6′ can be realized in such a way that the indentations 12′, or corresponding indentations 12′, can be realized additionally or (not shown as such in the drawings) alternatively on an inner side 32 of the annular blank 6′. FIGS. 8 and 9 show representations, analogous to FIGS. 3 and 4, for such indentations 12′ on the inner side 32 of the annular blank 6′.

Further examples are shown in the following, the references being used analogously in each case.

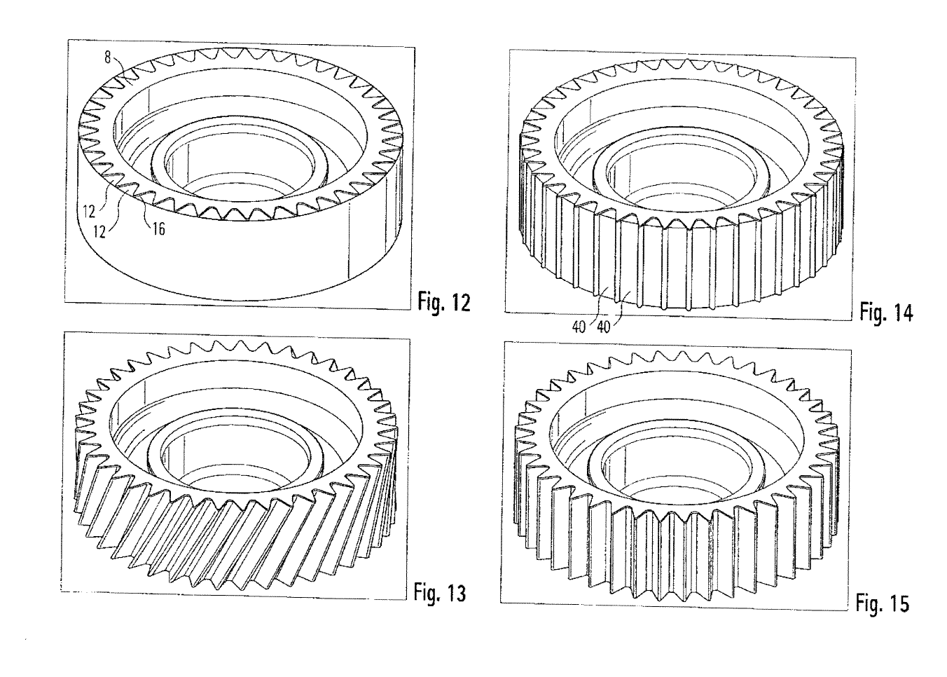

FIG. 12 shows an exemplary embodiment of a blank, according to the invention, of a spur gearwheel, and FIG. 13 shows the spur gearwheel made therefrom. It can be seen that the surface 8 in this case is a surface that defines a flat surface; in the case shown, the surface 8 is an outside face of the blank. The indentations 12 are again realized and disposed in a uniform manner, this being on a circular line. The edge regions 16 each have a U shape or V shape. The invention is suitable both for straight-toothed wheels and for helically toothed wheels.

FIG. 14 shows a further exemplary embodiment of a blank, according to the invention, of a spur gearwheel, and FIG. 15 shows the spur gearwheel made therefrom. In the case of this example, further indentations 40 are provided for the realization of further chamfers, or roundings 40, on the subsequent tooth crests.

The method according to the invention for producing a machine component 2 that has teeth 4 comprises: (a) producing a blank 6 of the machine component 2, the blank 6 having a surface 8 provided to constitute outside-face end regions 10 of the teeth 4; (b) making indentations 12 of the blank 6, preferably by a forming or pressing operation, so that boundaries 14 of the indentations 12 constitute edge regions 16 of the surface 8; (c) making tooth flanks 18 of the teeth 4 by a milling or grinding operation, so that the outside-face end regions 20 of the tooth flanks 18 directly adjoin regions 22 of the indentations 12 that remain after the milling operation.

In particular, in the case of (c), the indentations 12 can serve as entrance surfaces or exit surfaces for the milling or grinding operation. Particularly advantageously, in (c) the milling or grinding operation is effected in such a way that the remaining regions 22 constitute chamfer surfaces between the tooth flanks 18 and the surface 8. In this way, corresponding chamfers can be produced particularly easily.

The blank 6 can be, in particular, a blank 6 as described above.

Preferably in respect of the method, (a) and (b) can be performed as part of one work process, highly preferably simultaneously. In particular, it can be provided that in (a) the blank is produced by a forging operation.

1. A blank of a machine component comprising teeth having a surface provided to constitute outside-face end regions of the teeth, the surface comprising indentations, boundaries of the indentations constituting edge regions of the surface.

2. A blank according to claim 1, wherein the indentations are realized by a forming or pressing operation.

3. A blank according to claim 1, wherein the surface defines a cylindrical surface, a conical surface, or a flat surface.

4. A blank according to claim 1, wherein the indentations are realized and disposed in a uniform manner.

5. A blank according to claim 1, wherein each edge region of the surface has a U shape or V shape.

6. A blank according to claim 1, additionally having a further surface, the further surface being provided to be at least partially removed by a milling or grinding operation, for the purpose of realizing tooth flanks of the teeth, the boundaries of the indentations each constituting a further edge region in the form of an edge region of the further surface.

7. A blank according to claim 1, wherein in a section through a center of one of the indentations, and as viewed perpendicularly in relation to the surface, the angle included by, on the one hand, the end regions of the one indentation that adjoin one another at the edge region and, on the other hand, the surface, is between 100° and 170°.

8. A blank according to claim 7 wherein the angle is between 115° and 155°.

9. A blank according to claim 7, wherein the angle is between 130° and 140°.

10. A blank according to claim 1, the teeth being teeth of a running toothing.

11. A blank according to claim 1, the machine component being a gearwheel or a toothed rack.

12. m A blank according to claim 1, the machine component being a spur wheel or a crown wheel or a bevel wheel.

13. A blank according to claim 1, in the form of an annular blank, the indentations being made on an inner side and/or on an outer side of the annular blank.

14. A method for producing a machine component that has teeth, comprising:
(a) producing a blank of the machine component, the blank having a surface provided to constitute outside-face end regions of the teeth;
(b) making indentations of the blank so that boundaries of the indentations constitute edge regions of the surface; and
(c) making tooth flanks of the teeth by a milling or grinding operation, so that outside-face end regions of the tooth flanks directly adjoin regions of the indentations that remain after the milling operation.

15. A method according to claim 14, comprising making the indentations of the blank by a forming or pressing operation

16. A method according to claim 14, comprising effecting the milling or grinding operation in (c) in such a way that the remaining regions constitute chamfer surfaces between the tooth flanks and the surface.

17. Method according to claim 14, comprising performing (a) and (b) as part of one work process.

18. Method according to claim 14, comprising performing (a) and (b) simultaneously.

19. A method according to claim 14, comprising producing the blank in (a) by a forging operation.

20. A method according to claim 14, wherein the blank is a blank of a machine component comprising teeth having a surface provided to constitute outside-face end regions of the teeth, the surface comprising indentations, boundaries of the indentations constituting edge regions of the surface.
